(19) United States
(12) Patent Application Publication
(10) Pub. No.: US 2026/0259853 A1
(43) Pub. Date: Sep. 3, 2026

(54) VECTOR UNIT WITH AN ACTIVATION FUNCTION ACCELERATOR PIPELINE

(71) Applicant: Akeana, Inc., Santa Clara, CA (US)

(72) Inventors: Hing Yin Lai, San Jose, CA (US); Albert Anthony Martin, Sunnyvale, CA (US); Rabin Sugumar, Sunnyvale, CA (US)

(73) Assignee: Akeana, Inc., Santa Clara, CA (US)

(21) Appl. No.: 19/577,532

(22) Filed: Mar. 25, 2026

Related U.S. Application Data
(63) Continuation-in-part of application No. 19/551,690, filed on Feb. 27, 2026.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/941,793, filed on Dec. 16, 2025.
(60) Provisional application No. 63/983,964, filed on Feb. 16, 2026.

(51) Int. Cl. G06F 15/80; G06F 9/30

(52) U.S. Cl. CPC G06F 15/8053; G06F 9/30036

(57) ABSTRACT

A processor core is accessed. The processor core executes an instruction set architecture (ISA). The processor core includes a vector unit that includes one or more execution pipelines. The processor core calculates one or more activation functions associated with a machine learning model. The ISA is extended to include a custom vector instruction. The custom vector instruction is based on a core activation function. A first activation function within the one or more activation functions is based on the core activation function. The vector unit implements the custom vector instruction, based on a plurality of combinational logic cones. The plurality of combinational logic cones calculates a plurality of output bits associated with a result of the core activation function. The processor core computes the first activation function, based on the custom vector instruction. The custom vector instruction accesses the plurality of combinational logic cones.

### RELATED APPLICATIONS

This application claims the benefit of U.S. provisional patent applications “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, and “Memory Latency Hiding With A Memory Accelerator” Ser. No. 63/983,964, filed Feb. 16, 2026.

This application is also a continuation-in-part of U.S. patent application “Transformed Activation Function With ISA Extension” Ser. No. 19/551,690, filed Feb. 27, 2026, which claims the benefit of U.S. provisional patent applications “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, and “Memory Latency Hiding With A Memory Accelerator” Ser. No. 63/983,964, filed Feb. 16, 2026.

Each of the foregoing applications is hereby incorporated by reference in its entirety.

### FIELD OF ART

This application relates generally to matrix processing and more particularly to a vector unit with an activation function accelerator pipeline.

### BACKGROUND

The introduction of the integrated circuit radically altered the electronics landscape. While the concept of including multiple electronic components into a single electronic device is generally thought to date back to the 1920s, the notion of constructing multiple electronic devices on or in a common substrate did not emerge until a few decades later. German engineer Werner Jacobi filed a patent for an amplifying device in 1949. Radar scientist Geoffrey Dummer, along with engineers Sidney Darlington and Yasuo Tarui, proposed ideas for constructing active devices such as transistors within a common active area. A major challenge remained, however: how to electrically isolate the active devices so that the active devices did not interfere with one another. Over time, this and other shortcomings of the early proposals were surmounted by the invention of p-n junction isolation by Kurt Lehovec and the development of the planar process for construction of the electronic circuits. By 1959, Jack Kilby conceived multiple devices formed on a germanium semiconductor substrate, but required wires attached to the devices to form connections between active devices. Later that year, Robert Noyce fabricated a circuit on a silicon semiconductor substrate. Noyce's invention included not only the active devices, but also was wired on-chip. Noyce's circuit was based on the planar process.

Integrated circuits enabled vastly increased quantities of electronic circuits to be fitted together on single substrates. As fabrication techniques were improved, and the numbers of active devices quickly grew, more complex electronic systems could be constructed on and within the integrated circuits. The first commercially available microprocessor, the Intel 4004, was released in 1971. This 4-bit, single chip microprocessor was replaced by an 8-bit processor, the 8080, in 1974. The 8080 was replaced by the 16-bit 8086 in 1978, and so on. Other manufacturers were also actively manufacturing and selling competing microprocessor chips. Irrespective of the manufacturer, the improved chips, with their relatively low cost and wide availability, revolutionized markets such as home computing.

Today, integrated circuits (ICs) in general, and processors in particular, are found in a staggering range of products including smartphones, tablets, televisions, laptop and desktop computers, gaming consoles, “smart home” devices, and more. ICs enable and greatly enhance device capabilities, features, and utility, thereby rendering the devices far more useful and essential to the lives of users today. Even toys and games have greatly benefited from added integrated circuits. The chips better engage a wide range of players, from “first timers” to battle-hardened gaming veterans. Further, the chips produce strikingly realistic audio and graphics, enabling player immersion in fictional digital worlds and gaming scenarios. The chip-enhanced games can enable individual players and teams of players to engage in-game from locations around the world. The players can wear VR headsets, enabling them to immerse themselves in virtual worlds, surrounded by computer generated graphics and 3D audio. Living in the modern world without devices enabled by integrated circuits is difficult to imagine.

### SUMMARY

Increased computational performance has been and remains the principal design criterion of computer architects, designers, and engineers. The performance increases have included processing speed, increased storage, and greater power efficiency, among other improvements. The advances of specialized computing hardware and software for computationally intensive applications such as machine learning networks and models, respectively, have further accelerated this demand for increased performance. Today, networks such as neural networks are finding uses in many different application areas such as ecommerce, social media, video, finance, self-driving cars, and so on. Traditional means of computing are incapable of meeting these demands for processing speed and also confront architectural limitations. To counter these limitations, AI processors, accelerators, and units within a processor, etc. have been developed to meet the need of running neural networks, some of which can be quite large. One bottleneck that remains in the execution of these models is the computation of activation functions for each node of the network.

Disclosed techniques enable matrix processing. A processor core is accessed. The processor core executes an instruction set architecture (ISA). The ISA is a RISC-V® ISA. The processor core includes a vector unit, wherein the vector unit includes one or more execution pipelines. The number of pipeline stages comprises four pipeline stages. The processor core calculates one or more activation functions associated with a machine learning model. The ISA is extended. The extending includes a custom vector instruction. The custom vector instruction is based on a core activation function. A first activation function within the one or more activation functions is based on the core activation function. The custom vector instruction is implemented in the vector unit. The custom vector instruction comprises a vsig instruction. The implementing is based on a plurality of combinational logic cones. The plurality of combinational logic cones calculates a plurality of output bits associated with a result of the core activation function. The first activation function is computed by the processor core. The computing is based on the custom vector instruction. The custom vector instruction accesses, within the vector unit, the plurality of combinational logic cones.

A processor-implemented method for matrix processing is disclosed comprising: accessing a processor core, wherein the processor core executes an instruction set architecture (ISA), wherein the processor core includes a vector unit, wherein the vector unit includes one or more execution pipelines, and wherein the processor core calculates one or more activation functions associated with a machine learning model; extending the ISA, wherein the extending includes a custom vector instruction, wherein the custom vector instruction is based on a core activation function, and wherein a first activation function within the one or more activation functions is based on the core activation function; implementing, in the vector unit, the custom vector instruction, wherein the implementing is based on a plurality of combinational logic cones, wherein the plurality of combinational logic cones calculates a plurality of output bits associated with a result of the core activation function; and computing, by the processor core, the first activation function, wherein the computing is based on the custom vector instruction, and wherein the custom vector instruction accesses, within the vector unit, the plurality of combinational logic cones. In embodiments, each combinational logic cone within the plurality of combinational logic cones is based on one or more lookup tables (LUTs). Some embodiments comprise assigning, by each LUT within the one or more LUTs, to each input within a plurality of inputs, an output, wherein the assigning is based on the core activation function. Some embodiments comprise pipelining one or more combinational logic cones within the plurality of combinational logic cones, wherein the pipelining is based on an execution frequency of the processor core.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a vector unit with an activation function accelerator pipeline.

FIG. 2 is a flow diagram for pipelining lookup tables (LUTs).

FIG. 3 is an example node calculation within a neural network.

FIG. 4 is an example FP16 format number.

FIG. 5 is a block diagram of a vector unit with a vsig pipeline.

FIG. 6 is an example of producing core activation results based on a vector state.

FIG. 7 is an example of core activation function execution.

FIG. 8 is a block diagram of a multicore processor.

FIG. 9 is a block diagram of a pipeline.

FIG. 10 is a design flow for semiconductor logic generation.

FIG. 11 is a system diagram for a vector unit with an activation function accelerator pipeline.

### DETAILED DESCRIPTION

With the increased use of artificial intelligence (AI) to summarize email and text messages, to predict the order of apps accessed by time of day, to write clear and concise documents, and to navigate the seemingly endless layers of customer support, among many other application areas, many processors now include an artificial intelligence (AI) accelerator unit. The AI unit can accelerate the implementation of a machine learning model such as a neural network, convolutional neural network, transformer, large language model (LLM), and so on. Dedicated hardware acceleration is available to further speed up these functions, sometimes comprising tens, hundreds, or thousands of cores across many chips, boards, racks, and data centers. However, many significant bottlenecks remain. For example, when executing a large machine learning model, processing, memory access, and network bandwidth can be performance limitations, especially when sending large amounts of data between and among AI accelerators.

A further performance limitation can be found in the calculating techniques used for calculating each node within a machine learning model. In a neural network, for example, an activation function can be used to determine whether a node within a machine learning network should be activated during execution. The activation function can further determine the output of a node based on a sum of the weighted inputs (e.g., sum of products) to the node. The activation function can be based on a calculation of a variety of functions such as tanh, sigmoid, ReLU, softmax, and so on. These functions can be time consuming for a processor to calculate based on library function calls. Often, these functions are calculated through the use of a library call to a machine learning library such as PyTorch. However, these calls can be inefficient due to processing overhead, thereby wasting crucial and valuable processing time. The processing problem is further compounded when calculating larger machine learning models because of the sizes of the models. The larger machine learning models can comprise millions or billions of nodes, each requiring the calculation of an activation function, thereby resulting in a significant performance bottleneck.

Disclosed techniques enable matrix processing. A processor core is accessed. The processor core executes an instruction set architecture (ISA). The processor core includes a vector unit, wherein the vector unit includes one or more execution pipelines. The processor core calculates one or more activation functions associated with a machine learning model. The ISA is extended. The extending includes a custom vector instruction. The custom vector instruction is based on a core activation function. A first activation function within the one or more activation functions is based on the core activation function. The custom vector instruction is implemented in the vector unit. The implementing is based on a plurality of combinational logic cones. The plurality of combinational logic cones calculates a plurality of output bits associated with a result of the core activation function. The first activation function is computed by the processor core. The computing is based on the custom vector instruction. The custom vector instruction accesses, within the vector unit, the plurality of combinational logic cones.

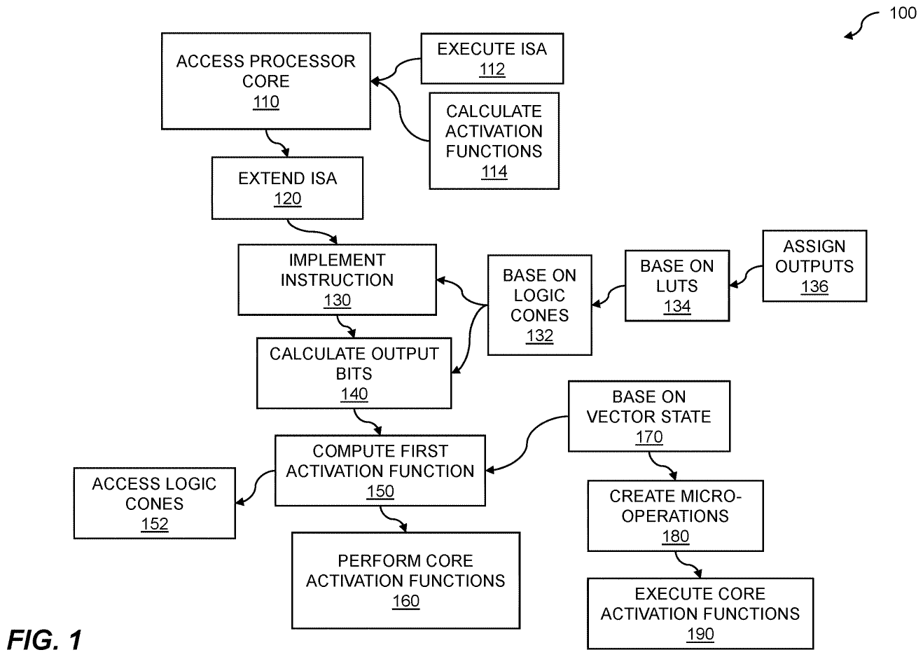

FIG. 1 is a flow diagram for a vector unit with an activation function accelerator pipeline. The flow 100 includes accessing 110 a processor core. The processor core can include a single processor core, a multiprocessor core, and so on. The processor core can be based on an architecture such as an industry standard architecture. The processor core architecture can include an ARM® processor, a RISC-V® processor, and the like. The processor core can comprise an ASIC, an FPGA, etc. In the flow 100, the processor core executes 112 an instruction set architecture (ISA). The ISA defines a set of instructions that can be executed by the processor core. The ISA can specify operations that can be performed by the processor. The ISA is associated with a specific processor architecture. In embodiments, the ISA is a RISC-V® ISA. The processor core includes a vector unit, wherein the vector unit includes one or more execution pipelines. The one or more execution pipelines can enhance processor core performance by enabling parallel execution of operations such as micro-operations. The processor core calculates 114 one or more activation functions associated with a machine learning model. The activation function is used to determine whether a network node, such as a neuron within a neural network, is activated. The activation function can determine whether the particular neuron is essential to the operation of the neural network for a given input.

The flow 100 includes extending 120 the ISA, wherein the extending includes a custom vector instruction, wherein the custom vector instruction is based on a core activation function, and wherein a first activation function within the one or more activation functions is based on the core activation function. An ISA can be extended with a custom instruction such as a custom vector instruction. The extension can be performed via open or reserved opcode space, controls to determine how to interpret opcode bits, and so on. The custom vector instruction can include a vector instruction associated with a core activation function, where a core activation function can be used to efficiently calculate an activation function. In embodiments, the core activation function is based on a sigmoid function. Thus, the custom vector instruction can compute a sigmoid function. In embodiments, the custom vector instruction comprises a vsig instruction. In a usage example, the activation function can include a tanh (x) function. The tanh (x) function can be calculated using a sigmoid function, where the sigmoid function can be calculated by executing a plurality of library function calls. Instead, the tanh (x) can be calculated using the vsig instruction. In disclosed implementations, the vsig instruction can be computed in four cycles as opposed to the many cycles required for the library function calls. In other embodiments, the core activation function is based on an exponential function (EXP). Thus, in embodiments, the custom vector instruction comprises a vexp instruction.

The flow 100 includes implementing 130, in the vector unit, the custom vector instruction. In the flow 100, the implementing is based on a plurality of combinational logic cones 132. The implementing the custom instruction can direct how the ISA processor executes the custom command. The implementing the custom command can be based on instructions such as vector instructions that are available for the ISA architecture. A combinational logic cone can include nonsequential logic that can generate an output from values provided to the logic cone by one or more inputs. In embodiments, each combinational logic cone within the plurality of combinational logic cones is based on one or more lookup tables (LUTs) 134. The LUTs can include tables of varying sizes. The LUTs can be populated based on an activation function. Embodiments can include assigning 136, by each LUT within the one or more LUTs, to each input within a plurality of inputs, an output, wherein the assigning is based on the core activation function. Each input to a logic cone can be used to compute an output from the logic cone. The inputs can be “fully connected” to the logic cones, where each input can be connected to each logic cone used to compute an output. The logic cones can be reduced, simplified, optimized, and so on. In a usage example, a logic cone is optimized using a software optimization tool. The resulting logic cone may be independent of a given input, thus rendering the given input a “don't care.” The size of the LUT can become large when all combinational logic functions within a plurality of combinational logic functions are associated with each input bit within the plurality of binary inputs. Since the differences between combinational logic functions can be small, some combinational logic functions can be omitted, relying instead on interpolation. In embodiments, the transforming includes interpolating linearly one or more combinational logic functions within the plurality of combinational logic functions associated with each input bit within the plurality of binary inputs. Other interpolation techniques can be used, such as polynomial interpolation, inverse distance interpolation, spline interpolation, cubic spline interpolation, etc. The linear interpolation can be based on a quantization. The interpolating linearly can be based on a quantization of four.

The LUT can be stored during the assigning, during use, and so on. The memory hierarchy can be coherent or non-coherent. The assigning a binary output to each binary input within the plurality of binary inputs can be based on an algorithm, a heuristic, a function, and so on. In embodiments, each binary input within the plurality of binary inputs comprises a floating-point 16 (FP16) format number. While the half-precision FP16 format is mentioned, other floating point representations, such as sign-precision FP32, double-precision FP64, and so on, can also be used. In embodiments, the plurality of binary inputs comprises all possible values of the FP16 format number. The possible decimal values for FP16 can range from −65,504 to +65,504.

In the flow 100, the plurality of combinational logic cones calculates a plurality of output bits 140 associated with a result of the core activation function. The result of the core activation function can be used to calculate an activation function output. Returning to the usage example of a tanh (x) function used as the activation function, the combinational logic cones can be used to calculate a vsig output. The vsig output can then be used to calculate the tanh value. Note that the combinational logic cones can be pipelined. Embodiments include pipelining one or more combinational logic cones within the plurality of combinational logic cones, wherein the pipelining is based on an execution frequency of the processor core. The pipelining can enable portions of the calculating the core activation function to be performed in parallel. The number of stages of the pipeline, which can include a pipeline within the vector unit, can be determined to meet a processing goal based on the execution frequency of the processor core. The number of stages is further based on the computational requirements of a given combinational logic cone. Thus, the pipeline can include one or more stages. In embodiments, a maximum number of pipeline stages within one or more combinational logic cones that were pipelined matches a number of pipeline stages within the execution pipeline within the vector unit. The pipeline stages can be implemented in other units of the processor core. In embodiments, the number of pipeline stages comprises four pipeline stages.

The flow 100 includes computing 150, by the processor core, the first activation function, wherein the computing is based on the custom vector instruction. The combinational logic cones, which can be pipelined, can be implemented within a vector unit of the processor.

In a usage example, the activation is based on a tanh function:

$$tanh ( x ) = 2 ( sigmoid ( 2 x ) - 1 ) \qquad Equation 1$$

The sigmoid function is based on an exponential, which can be calculated based on many function calls to a library of functions.

Equation 1 can be rewritten:

$$tanh ( x ) = 2 ( vsig ( 2 x ) - 1 ) \qquad Equation 2$$

By using the vsig custom vector instruction, the tanh function can be calculated in four vector cycles in disclosed embodiments.

In the flow 100, the custom vector instruction accesses 152, within the vector unit, the plurality of combinational logic cones. The combinational logic cones calculate the output bits for the core activation function, such as the vsig instruction. The output bits of the core activation function are then used to compute the activation function. Multiple core activation functions can be performed.

The flow 100 includes performing core activation functions 160 within four cycles of the processor core. Recall that the processor core includes a vector unit. The vector unit can calculate core activation function values, compute activation function values, and so on by executing a core activation instruction such as a pipelined, four-cycle vsig instruction. The vsig instruction operates on an amount of data. The data can be obtained from a register file, a vector register file, an immediate value, and so on. In embodiments, the processor core includes a vector register file, wherein each vector register within the vector register file comprises 2048 bits. The 2048 bits can include floating-point values based on a floating-point representation. The floating-point values are associated with an activation function. In embodiments, the activation function is based on a floating-point 16 data format (FP16). In practice, the vector register file can be any width. When the register file is 2048 bits, 128 total FP16 numbers can be represented in a single vector register file (2048 bits divided by 16-bits per FP16 number). All 128 FP16 numbers within a single vector register can be input to the execution pipeline to generate 128 core activation functions in parallel. Recall that the execution pipeline can comprise four stages. Thus, embodiments include performing 128 core activation functions within four cycles of the processor core. The four-stage pipeline can operate on data during each cycle, allowing for sustained back-to-back production of 128 core activation functions, such as the vsig instruction, for each cycle once the execution pipeline has been filled.

Discussed previously, the core activation function can be based on a vsig instruction, a vexp instruction, and so on. A variety of activation functions can be computed based on the core activation functions vsig and vexp. The custom vsig instruction can be used to compute one or more activation functions. In embodiments, the activation function comprises a hyperbolic tangent (tanh) function. Noted previously, the tanh (x) function can be computed in four vector cycles. In other embodiments, the activation function comprises a sigmoid linear unit function (SILU). The SILU is also generally known as the swish function. The swish function can be preferentially compared to a rectified linear unit (ReLU). The swish function is a non-monotonic function that changes smoothly in the region of zero compared to the abrupt change associated with the rectified linear unit (ReLU) function. In other embodiments, the activation function comprises a swish gated linear unit function (SwiGLU). The SwiGLU improves on the SILU in that it is self-gating. Further, the SILU can scale its inputs based on the activation values associated with those inputs. In embodiments, the custom vector instruction comprises a vexp instruction. The vexp instruction is able to efficiently compute exponential values for activation functions. In embodiments, the activation function comprises an exponential linear unit (ELU). The ELU is a non-linear activation function. The ELU provides a smooth, negative portion to an activation computation. In other embodiments, the activation function comprises a scaled exponential linear unit (SELU). The SELU includes features of the ELU with the addition of self-normalizing capabilities. In some embodiments, the core activation function and the activation function comprise a Gaussian error linear unit (GELU). As indicated, a machine learning model can use the GELU function as an activation function for one or more nodes. The process can explicitly implement the GELU function as a core activation function. Thus, no additional mathematical logic may be required to produce the activation function when the core activation function is a GELU.

In the flow 100, the computing is based 170 on a vector state, wherein the vector state includes a vector multiplier (vmul). In some embodiments, the vector multiplier, which can be a vector length multiplier, can be referred to as lmul or vlmul. A vector multiplier, vmul, can be associated with a custom instruction such as the vsig instruction. The vector multiplier can be used during decoding the custom vector instruction prior to execution of the custom vector instruction. In embodiments, the implementing includes creating 180, by a decode unit within the processor core, one or more vector micro-operations, wherein each operation within the one or more vector micro-operations is based on the core activation function, and wherein the creating is further based on the vmul. In a first usage example, a vsig instruction includes a vmul value of 1. The decoder can create a single vsig instruction that can include one or more vector micro-operations. The vsig can be executed in four vector unit cycles. In a second usage example, a vsig instruction includes a vmul value of 8. In this latter case, eight vsig instructions are created. The first vsig results are available after the fourth vector unit cycle. Recalling that execution queues within the vector unit can be pipelined, the second vsig results are available after the fifth vector unit cycle, and so on. The flow 100 includes executing 1024 core activation functions within eleven cycles of the processor core 190. Thus, computing an activation function based on the custom vector instruction can significantly improve machine learning model processing.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

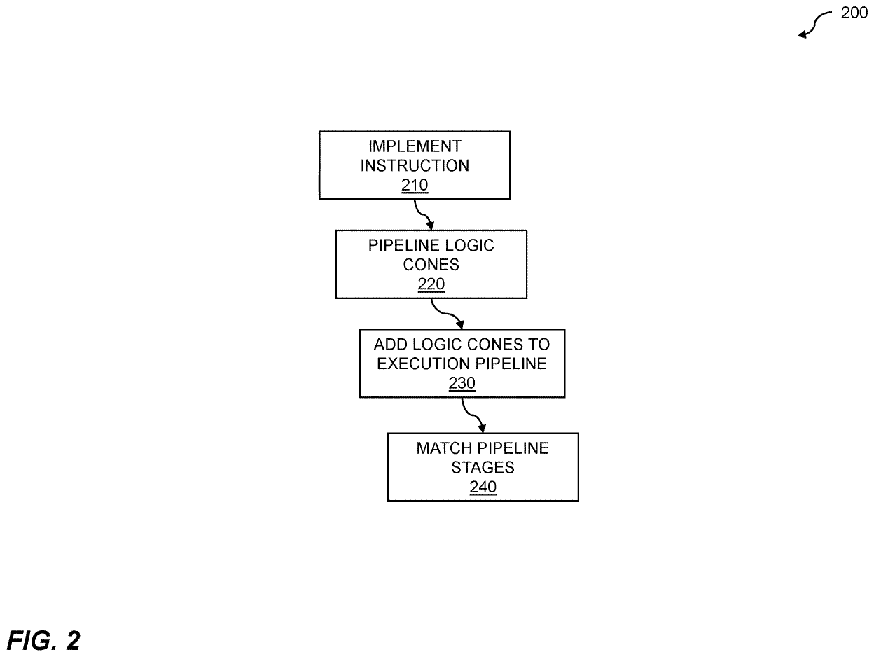

FIG. 2 is a flow diagram for pipelining lookup tables (LUTs). Discussed previously, a vector unit associated with a processor core can include one or more pipelines. The pipelines can speed computations, such as computing an activation function, by enabling operations to be executed in parallel. Recall that an instruction set architecture (ISA) can be extended by including a custom vector instruction that is based on a core activation function. The core activation function can include a vsig instruction, a vexp instruction, and so on. Recall also that the custom vector instruction can be implemented in a vector unit based on a plurality of combinational logic cones. The combinational logic cones calculate a plurality of output bits associated with the result of the core activation function. The combinational logic cones can be based on one or more lookup tables (LUTs). Thus, the calculating the plurality of output bits can also be pipelined. The result of the pipelining is that operations associated with the calculations of the output bits can be parallelized, thereby speeding up calculation throughput. The pipelining lookup tables support a vector unit with an activation function accelerator pipeline.

An activation function, which is based on a core activation function, can determine whether a node or neuron within a neural network should be activated during processing of a model such as the ML model. The activation function can transform a weighted sum of products associated with inputs to a neuron within the neural network. The output generated by the activation function can then be passed to one or more neurons in a subsequent layer of neurons within the neural network, passed to a neural network output, and so on. Since processing by the activation function of the weighted sum of products associated with the neuron can be computationally intensive, binary outputs assigned to the LUT can be transformed into combinational logical functions. The logical functions can be based on instructions native to a processor architecture and custom instructions that augment an instruction set architecture (ISA) associated with the processor.

A processor core is accessed. The processor core executes an instruction set architecture (ISA). The processor core includes a vector unit and one or more execution pipelines. The processor core calculates one or more activation functions associated with a machine learning model. The ISA is extended, where extending includes a custom vector instruction. The custom vector instruction is based on a core activation function. A first activation function within the one or more activation functions is based on the core activation function. The custom vector instruction is implemented in the vector unit. The implementing is based on a plurality of combinational logic cones. The plurality of combinational logic cones calculates a plurality of output bits associated with a result of the core activation function. The first activation function is computed by the processor core. The computing is based on the custom vector instruction. The custom vector instruction accesses, within the vector unit, the plurality of combinational logic cones.

The flow 200 includes implementing 210, in the vector unit, the custom vector instruction. The custom vector instruction can include a vector instruction that can efficiently compute output bit values for the combinational logic cones. In a usage example, an activation function based on tanh (x) is to be calculated. Using traditional methods, the tanh (x) values can be computed based on a sigmoid function, where the sigmoid function can be computed based on library function calls. Alternatively, the tanh (x) activation function can be computed based on a custom vector instruction such as a vsig vector instruction. The vsig vector function can be computed in four cycles compared to the many cycles required to compute the sigmoid function based on the library function calls. In embodiments, the custom vector instruction comprises a vsig instruction. The custom vsig instruction can be used to compute a variety of activation functions. In embodiments, the activation function comprises a hyperbolic tangent (tanh) function. Discussed previously, the tanh (x) function can be computed in four vector cycles. In other embodiments, the activation function comprises a sigmoid linear unit function (SILU). The SILU is also known as the swish function. The swish function is an improved activation function compared to a rectified linear unit (ReLU). In other embodiments, the activation function comprises a swish gated linear unit function (SwiGLU). The SwiGLU improves on the SILU because it is self-gating and can scale its inputs based on the activation values associated with those inputs. In embodiments, the custom vector instruction comprises a vexp instruction. The vexp instruction is able to efficiently compute exponential values for activation functions. In embodiments, the activation function comprises an exponential linear unit (ELU). The ELU is a non-linear activation function that includes a smooth, negative portion to an activation computation. In other embodiments, the activation function comprises a scaled exponential linear unit (SELU). The SELU includes features of the ELU and self-normalizing capabilities.

The flow 200 includes pipelining 220 one or more combinational logic cones within the plurality of combinational logic cones, wherein the pipelining is based on an execution frequency of the processor core. The technique of pipelining is well known to improve computational efficiency by enabling operations to be performed in parallel. The pipeline technique can be applied to the combinational logic cones. In order to obtain a target processing throughput, one or more stages can be added to the combinational logic cones. The number of stages can be based on the execution frequency or processor speed of the processor core.

In embodiments, the implementing includes adding 230, to an execution pipeline within the one or more execution pipelines, the plurality of combinational logic cones. Based on the execution frequency of the processor core, combinational logic cones can benefit from different numbers of execution pipelines. In a usage example, a first combinational logic cone benefits from two execution pipelines, while a second combinational logic cone benefits from four execution pipelines. In the flow 200, a maximum number of pipeline stages within one or more combinational logic cones that were pipelined matches 240 a number of pipeline stages within the execution pipeline within the vector unit. The maximum number of pipeline stages can include one or more stages. In embodiments, the number of pipeline stages can include four pipeline stages. In a usage example, the first combinational logic cone requires two execution pipelines. When executed with four execution pipelines, the third and fourth pipelines can include “register-to-register” or “latch-to-latch” transfers without other operations.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

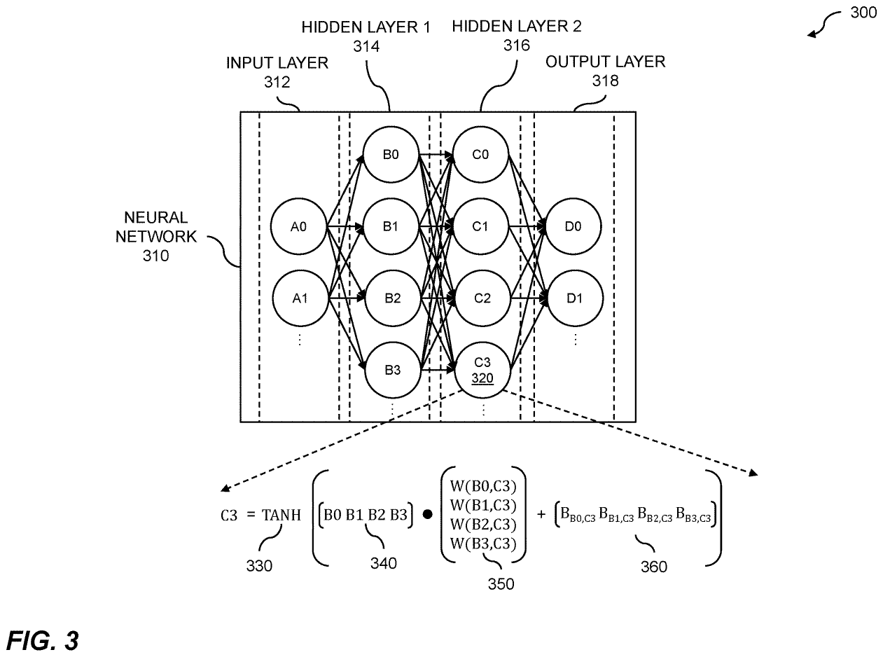

FIG. 3 is an example node calculation within a neural network. Discussed previously and throughout, a machine learning (ML) model can be executed on a network such as a neural network (NN). The neural network can include a convolutional neural network (CNN). The machine learning model can comprise any appropriate model such as an LLM, a transformer, etc. The NN comprises layers of processing elements called neurons. A neuron can perform one or more computations, where the computations can include applying one or more weights to one or more input values provided to the neuron. The resulting product or products can be summed inputs (e.g., sums of products). The input values can include values generated by an activation function associated with a previous or “upstream” neuron, an input to the neural network, and so on. The neuron can apply an activation function to the sum of products to generate an output. The output of the neuron can be provided as an input to a neuron in a subsequent or “downstream” neuron, an output of the NN, and the like. The computations performed by the neuron can be based on a custom instruction added to an instruction set architecture (ISA). The node calculation is supported by a vector unit with an activation function accelerator pipeline.

Node calculations are performed by nodes or neurons within a neural network (NN) 300. An example NN 310 is shown. The NN includes one or more layers. In the example shown, the layers include an input layer 312, a first hidden layer, hidden layer 1 314, a second hidden layer, hidden layer 2 316, and an output layer 318. While two hidden layers are shown within the example, any number of hidden layers can be included within a neural network. Each layer can include one or more neurons. The neural network 310 includes two neurons, A0 and A1, in the input layer; four neurons, B0, B1, B2, and B3 in hidden layer 1; four neurons, C0, C1, C2, and C3 in hidden layer 2; and two neurons in the output layer, D0 and D1. The number of neurons on each hidden layer can be substantially similar or can be different. The number of neurons in a hidden layer can be equal to the sum of the number of neurons in the input layer and the number of neurons in the output layer. A neuron in a hidden layer can be coupled to one or more neurons in a previous or upstream layer. In the example shown, each node in a hidden layer is coupled to each node in a previous layer. This coupling technique is referred to as fully connected to the previous layer.

An example node calculation for node C3 320 is shown. The calculation performed by node C3 can include an activation function. One or more activation functions can be included in the neural network. A variety of functions can be used to calculate the activation function. In embodiments, the one or more activation functions comprise a hyperbolic tangent (tanh) function 330. Other functions can be chosen for the activation function. In embodiments, the other activation functions can be based on a sigmoid function, a sigmoid linear unit function (SILU), a swish gated linear unit function (SwiGLU), an exponential linear unit (ELU), a scaled exponential linear unit (SELU), a Gaussian cumulative distribution function (GELU), and so on. The activation function can be applied to a vector sum of a sum of products and a bias. Discussed above, the sum of products is computed by multiplying output from a previous layer by weights associated with the node. Since hidden layer 2 is fully connected to hidden layer 1, the inputs to C3 include the outputs of B0, B1, B2, and B3 as represented by vector 340. The weights associated with C3 include weights W(B0, C3), W(B1, C3), W(B2, C3), and W(B3, C3) as represented by vector 350. Biases can be added to the sum of products. The biases can include BB0,C3, BB1,C3, BB2,C3 and BB3,C3 represented by vector 360. The result of the node calculation by node C3 can be sent to the nodes DO and D1 in the output layer.

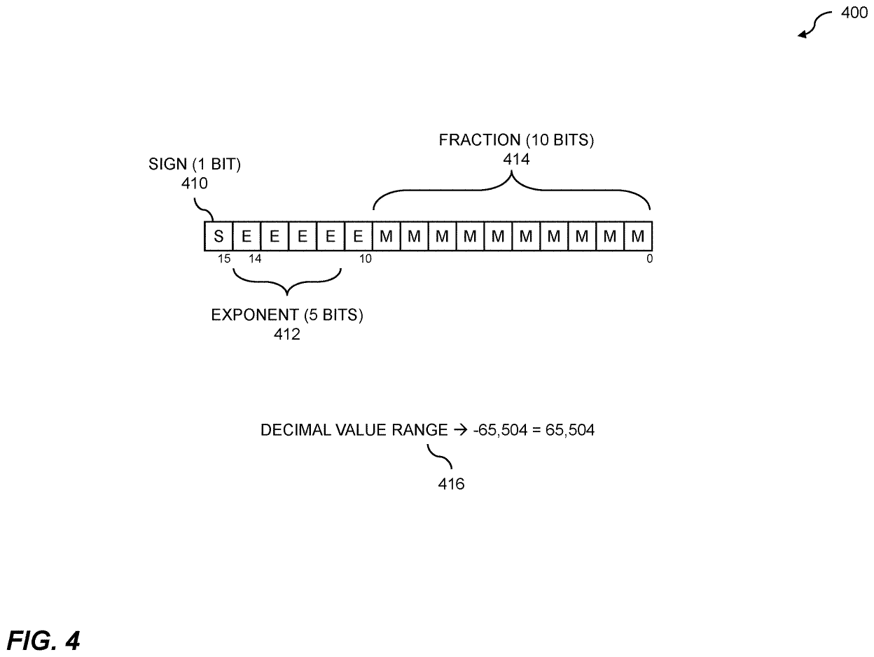

FIG. 4 is an example FP16 format number. Calculations performed by nodes within a network such as a neural network can be performed for each binary input within a plurality of binary inputs to the neural network. The binary inputs can be based on a number system representation. The computations performed by a node such as a hidden node within the neural network can be performed on various types of data. The types of data can include audio data, image data, video data, natural language data, and so on. The data on which the computations are performed can have a wide dynamic range. In a usage example, input binary data on which the computations are performed can include image data that can include a wide range of values. As a result of the wide dynamic range associated with the input data, an integer number system representation such as signed integer, or a real number system representation, may not be sufficiently broad to handle the numeric dynamic range for the processing tasks. Instead, a floating-point representation is better suited to the processing task. The floating-point number system representations can include a half-precision representation (16-bit), a single-precision representation (32-bit), a double-precision representation (64-bit), and so on. In embodiments, each binary input within the plurality of binary inputs comprises a floating-point 16 (FP16) format number. The FP16 floating point number representation supports computations associated with a vector unit with an activation function accelerator pipeline. Any floating-point representation can be used including FP64, FP32, FP8, BF16, microscaling formats such as MXFP8, MXFP16, and so on.

The FIG. 400 shows a floating-point 16 (FP16) representation. The FP16 representation is a “little endian” representation, where the least significant bit (LSB), bit 0, is at the right end of the FP16 representation, and the most significant bit (MSB), bit 15, is at the left end of the FP16 representation. The FP16 representation includes a sign bit, bit 15 410. A sign bit equal to zero can represent a positive number, and a sign bit equal to one can represent a negative number. The FP16 representation further includes a five-bit exponent 412 that is stored in bits 10 to 14. The FP16 representation further includes a 10-bit mantissa 414 that is stored in bits 0 to 9. The mantissa can represent a fraction. The FP16 representation can therefore represent positive numbers and negative numbers. In embodiments, the plurality of binary inputs comprises all possible values of the FP16 format number. That is, the binary values stored within the fields of the FP16 representation can represent decimal values 416, ranging between −65,504 and +65,504. When a greater range of decimal values is required for one or more processing tasks, the other floating point representations, such as single-precision FP32, double-precision FP64, etc., can be used.

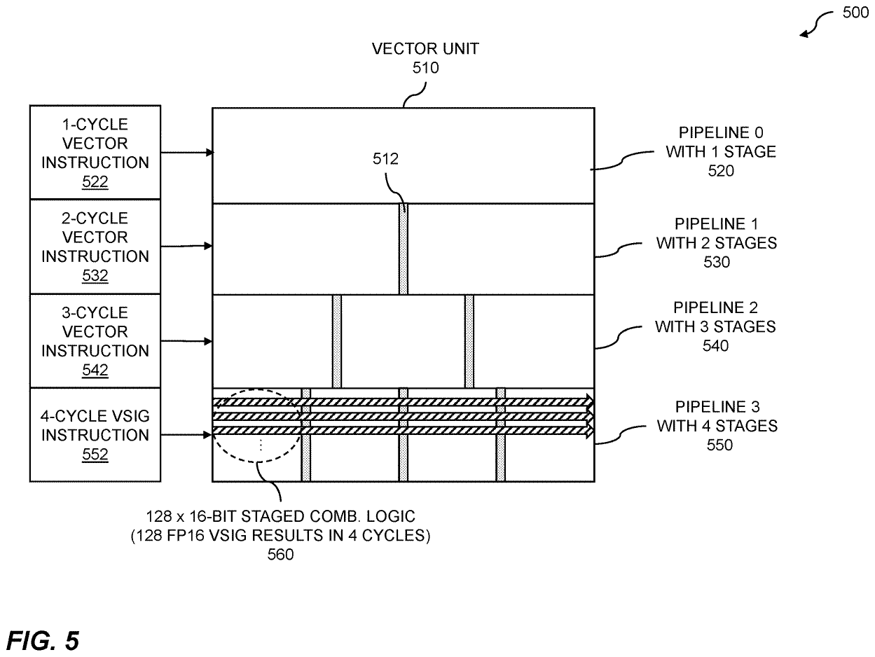

FIG. 5 is a block diagram of a vector unit with a vsig pipeline. Discussed previously, a custom vector instruction can be used to extend an instruction set architecture (ISA). The ISA can be associated with a processor core architecture such as an ARM® architecture, a RISC-V® architecture, and so on. The custom instruction is based on a core activation function. The core activation can include a sigmoid activation function, an exponential activation function, and so on. In embodiments, the custom vector instruction comprises a vsig instruction. The custom vector instruction can be implemented in a vector unit associated with the processor core. Noted previously, implementing the custom instruction is based on one or more combinational logic cones, where the logic cones calculate output bits of the core activation function. Thus, an activation function can be computed based on the custom vector instruction. The custom vector instruction accesses, within the vector unit, the one or more combinational logic cones.

Recall that in embodiments, each combinational logic cone within the plurality of combinational logic cones is based on one or more lookup tables (LUTs). The execution of the logic cones can generate the values associated with a core activation function faster than relying on library functional calls to compute the value on the fly. Each entry in the LUT can be assigned an output to each input. The outputs correspond to a core activation function. Embodiments include assigning, by each LUT within the one or more LUTS, to each input within a plurality of inputs, an output, wherein the assigning is based on the core activation function. An input may impact a given output or may not impact the given output (e.g., a “don't care”). Since the combinational logic cones can be large, some logic cones can benefit from pipelining the logic cones. The pipelining can enable portions of a combinational logic cone to be executed in parallel. Embodiments include pipelining one or more combinational logic cones within the plurality of combinational logic cones, wherein the pipelining is based on an execution frequency of the processor core. Based on the computational complexity of a given combinational logic cone, and on execution frequency of the processor core, the pipeline associated with the combinational logic cone can include one or more stages. In embodiments, the number of pipeline stages comprises four pipeline stages.

The FIG. 500 includes a vector unit 510. The vector unit can include one or more pipelines. A pipeline within the one or more pipelines can include one or more stages. Based on the complexity of a vector instruction associated with a core activation function, the vector instruction can be completed in one or more vector unit cycles. A vector instruction can be assigned to a pipeline, where the pipeline can include a number of stages appropriate to the vector instruction. Stages within a pipeline can be partitioned using latches, registers, flip-flops, etc., such as shown at 512. In FIG. 500, a 1-cycle vector instruction 522 is assigned to pipeline 0 with one stage 520; a 2-cycle vector instruction 532 is assigned to pipeline 1 with two stages 530; and a 3-cycle vector instruction 542 to pipeline 2 with three stages 540. Recall the number of pipeline stages for the core activation function can include four pipeline stages. Thus, a 4-cycle vsig instruction 552 can be assigned to pipeline 3 with four stages 550. When a one-cycle, two-cycle, or three-cycle instruction is assigned to a four-stage pipeline such as 550, the stages following the number of stages associated with the vector instruction can serve as “pass-through” stages. That is, data, state information, etc. can pass through a pipeline stage by transferring data etc. from latch to latch or register to register. This technique enables one-cycle, two-cycle, and three-cycle instructions to be executed in a four-stage pipeline. Some logic cones used in the calculation of the core activation function may be able to execute in less than four processor cycles within the preferred processor frequency. In this case, the “extra” cycles can simply forward results.

The vector unit can calculate core activation function values, compute activation function values, and so on by executing a core activation instruction such as a four-cycle vsig instruction. The vsig instruction operates on an amount of data. The data can be obtained from a register file, a vector register file, an immediate value, and so on. In embodiments, the processor core can include a vector register file, wherein each vector register within the vector register file comprises 2048 bits. The 2048 bits can include floating-point values based on a floating-point representation. The floating-point values are associated with an activation function. In embodiments, the activation function is based on a floating-point 16 data format (FP16). The decimal values represented by FP16 include+/−65,504. The four-stage pipeline can operate on data during each cycle, allowing for staging execution of vector instructions such as the vsig instruction. A first vsig instruction can be executed in four cycles 560. Additional instructions can be added to the pipeline. Embodiments include performing 128 core activation functions within four cycles of the processor core. Thus, additional results based on 128 FP16 values are completed on each cycle subsequent to the first four cycles.

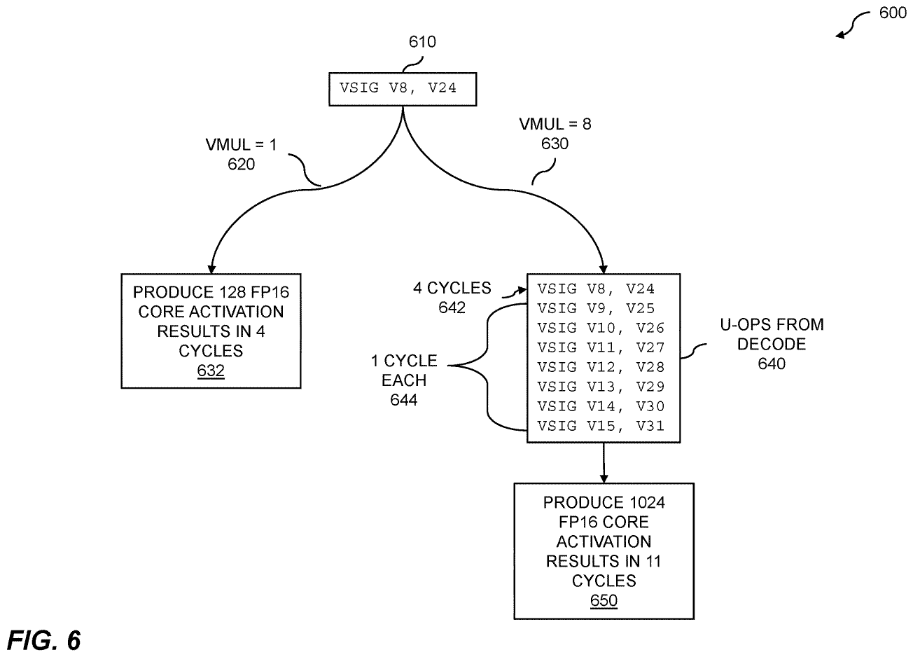

FIG. 6 is an example of producing core activation results based on a vector state. A processor core, such as a processor core based on a RISC-V® architecture, can include a vector unit. The vector unit can be used to process vector operations such as vector addition, vector subtraction, vector multiplication, vector division, vector cross-product, and so on. The RISC-V® is based on an instruction set architecture (ISA) which can be extended with custom instructions. The custom instructions that extend the RISC-V® ISA can include core activation functions. The core activations can be used to efficiently compute activation functions associated with a machine learning (ML) mode. One example of a custom vector instruction can include the vsig instruction. The vsig instruction has been described as a custom function that can be based on a plurality of combinational logic cones. The custom instruction can be used to compute an activation function, where the computing based on the custom function is more efficient (e.g., requires fewer vector unit cycles) than computing the activation function using library function calls. The vsig custom instruction can be executed in a vector unit associated with the processor. The vsig custom instruction can further be executed in an accelerator, an ASIC, an FPGA, or other element external to and coupled to the processor. A multiplier, vmul, can be associated with the vsig instruction. The vmul can indicate how many vsig microoperations are to be performed based on decoding the vsig custom instruction. Producing core activation results based on a vector state enables a vector unit with an activation function accelerator pipeline.

The FIG. 600 shows an example vsig instruction 610. The vsig instruction can use vector register V24 as a source, and vector register V8 as a destination. Two example values for vmul are shown. Discussed previously, the vsig instruction is based on a plurality of combinational logic cones. The combinational logic cones can be added to a pipeline within a plurality of pipelines. The pipelines can include a number of pipeline stages. In embodiments, the number of pipeline stages comprises four pipeline stages. Thus, a computation associated with an activation function can include four cycles. A number of activation functions can be performed within those four cycles. Embodiments include performing 128 core activation functions within four cycles of the processor core 632. Two cases with different values of vmul are shown. Callout 620 shows an execution example where vmul=1. In this case, the vsig instruction can produce 128 FP16 core activation function results in four cycles. The four cycles can be associated with the vector unit associated with the processor core. The four cycles can be associated with an element external to the vector unit such as an accelerator, a core, an ASIC, an FPGA, etc.

Another execution example where vmul=8 is also shown at 630. In embodiments, the implementing includes creating, by a decode unit within the processor core, one or more vector micro-operations, wherein each operation within the one or more vector micro-operations is based on the core activation function, and wherein the creating is further based on the vmul. For the case of a vsig instruction with vmul=8, eight vsig micro-operations, such as the eight vsig micro-operations shown 640, can result from decoding the vsig instruction. Noted above, the first vsig operation requires four cycles to process 642. Since the implementing the vsig instruction is pipelined, a new vsig micro-operation can be introduced at each cycle 644. Thus, the first vsig micro-operation completes after the fourth cycle, the second vsig micro-operation completes after the fifth cycle, and so on, for the eight micro-operations. Embodiments include executing 1024 core activation functions within 11 cycles of the processor core 650. The 1024 core activation functions can be stored in the destination register, a register file, a cache, etc.

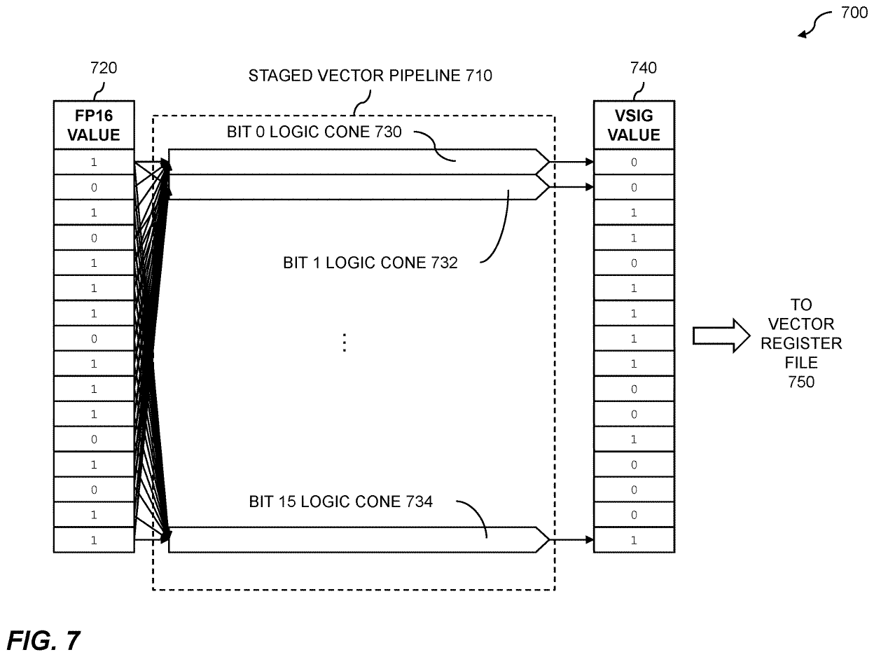

FIG. 7 is an example of core activation function execution. A custom vector instruction can be implemented in a vector unit associated with a processor core. The implementing the custom instruction is based on a plurality of combinational logic cones. Each combinational logic cone can be based on one or more lookup tables (LUTs). Outputs based on a core activation function can be assigned to each input. Thus, based on input bits, such as input bits within an FP16 representation, the combinational logic cones associated with each output bit can compute the output bits. The output bits, which can include bits within an FP16 representation, can represent a core activation function value. The core activation function can include a vsig function, a vexp function, and so on. The core activation value can be used to generate an activation function value. The computing the activation function from the core activation requires four vector unit cycles. The four cycles are fewer than the number of cycles required to compute the activation function value using library function calls. The 16-bit pipelined lookup table enables a vector unit with an activation function accelerator pipeline.

The FIG. 700 includes staged vector pipelines 710. Recall from previous discussions that the implementing a custom vector instruction, such as a vsig instruction, is based on a plurality of combinational logic cones. A combinational logic cone can generate an output bit for a core activation function such as the vsig function. The combinational logic cones can be pipelined. Embodiments include pipelining one or more combinational logic cones within the plurality of combinational logic cones, wherein the pipelining is based on an execution frequency of the processor core. The combinational logic cones can be executed. In embodiments, the implementing includes adding, to an execution pipeline within the one or more execution pipelines, the plurality of combinational logic cones. While the figure shows that each input bit is fully connected to each combinational logic cone, some inputs can be eliminated as inputs to a given logic cone. Such “don't cares” can result from logic simplification, logic reduction, logic optimization, and so on. Since there are 16 output bits shown in the example, 16 logic cones, such as bit 0 logic cone 730, bit 1 logic cone 732, up to bit 15 logic cone 734 can be added to the staged vector pipeline. An FP16 value 720 is provided to the staged vector pipeline. Each combinational logic cone generates its output bit based on the provided input. The output bits comprise the vsig value 740. The vsig value can be send to a vector register file 750, where the vsig value can be used to compute an activation function value.

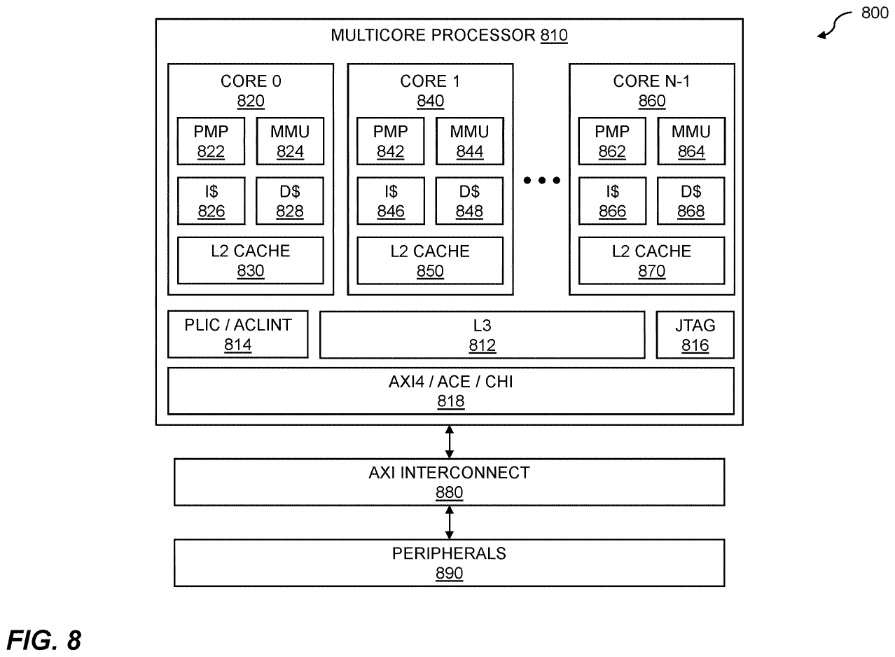

FIG. 8 is a block diagram of a multicore processor. The processor, such as a RISC-V® processor, an ARM® processor, or other suitable processor type, can include a variety of elements. The elements can include processor cores including multiprocessor cores, one or more caches including local caches and shared caches, memory protection and management units, local storage, and so on. In one or more exemplary implementations, the processor core enables a vector unit with an activation function accelerator pipeline. The elements of the multicore processor can further include one or more of a private cache, a test interface such as a joint test action group (JTAG) test interface, one or more interfaces to a network such as a network-on-chip, shared memory, peripherals, and the like. A processor core is accessed. The processor core executes an instruction set architecture (ISA). The processor core includes a vector unit. The processor core executes an instruction set architecture (ISA). The processor core includes a vector unit. The ISA is extended, wherein the extending includes a custom vector instruction. The custom vector instruction is based on a core activation function. A first activation function within the one or more activation functions is based on the core activation function. The custom vector instruction is implemented in the vector unit. The implementing is based on a plurality of combinational logic cones. The plurality of combinational logic cones calculates a plurality of output bits associated with a result of the core activation function. The custom vector instruction is computed by the processor core, wherein the computing is based on the custom vector instruction. The custom vector instruction accesses, within the vector unit, the plurality of combinational logic cones.

In the block diagram 800, the multicore processor 810 can comprise two or more processors, where the two or more processors can include homogeneous processors, heterogeneous processors, etc. In the block diagram, the multicore processor can include N processor cores such as core 0 820, core 1 840, core N−1 860, and so on. Each processor can comprise one or more elements. In one or more implementations, each core, including cores 0 through core N−1, can include a physical memory protection (PMP) element, such as PMP 822 for core 0; PMP 842 for core 1, and PMP 862 for core N−1. In a processor architecture such as the RISC-V® architecture, a PMP can enable processor firmware to specify one or more regions of physical memory such as cache memory of the shared memory, and to control permissions to access the regions of physical memory. The cores can include a memory management unit (MMU) such as MMU 824 for core 0, MMU 844 for core 1, and MMU 864 for core N−1. The memory management units can translate virtual addresses used by software running on the cores to physical memory addresses with caches, the shared memory system, etc.

The processor cores associated with the multicore processor 810 can include caches such as instruction caches and data caches. The caches, which can comprise level 1 (L1) caches, can include an amount of storage such as 16 KB, 32 KB, and so on. The caches can include an instruction cache I$ 826 and a data cache D$ 828 associated with core 0; an instruction cache I$ 846 and a data cache D$ 848 associated with core 1; and an instruction cache I$ 866 and a data cache D$ 868 associated with core N−1. In addition to the level 1 instruction and data caches, each core can include a level 2 (L2) cache. The level 2 caches can include L2 cache 830 associated with core 0; L2 cache 850 associated with core 1; and L2 cache 870 associated with core N−1. The cores associated with the multicore processor 810 can include further components or elements. The further elements can include a level 3 (L3) cache 812. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 814. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 816. The JTAG can provide a boundary within the cores of the multicore processor. The JTAG can enable fault information to a high precision. The high-precision fault information can be critical to rapid fault detection and repair.

The multicore processor 810 can include one or more interface elements 818. The interface elements can support standard processor interfaces including an Advanced extensible Interface (AXI®) such as AXI4®, an ARM® Advanced extensible Interface (AXI®) Coherence Extensions (ACE®) interface, an Advanced Microcontroller Bus Architecture (AMBA®) Coherence Hub Interface (CHI®), etc. In the block diagram 800, the interface elements can be coupled to the interconnect. The interconnect can include a bus, a network, and so on. The interconnect can include an AXI® interconnect 880. In one or more implementations, the network can include network-on-chip functionality. The AXI® interconnect can be used to connect memory-mapped “master” or boss devices to one or more “slave” or worker devices. In the block diagram 800, the AXI interconnect can provide connectivity between the multicore processor 810 and one or more peripherals 890. The one or more peripherals can include storage devices, networking devices, and so on. The peripherals can enable communication using the AXI™ interconnect by supporting standards such as AMBA™ Version 4, among other standards.

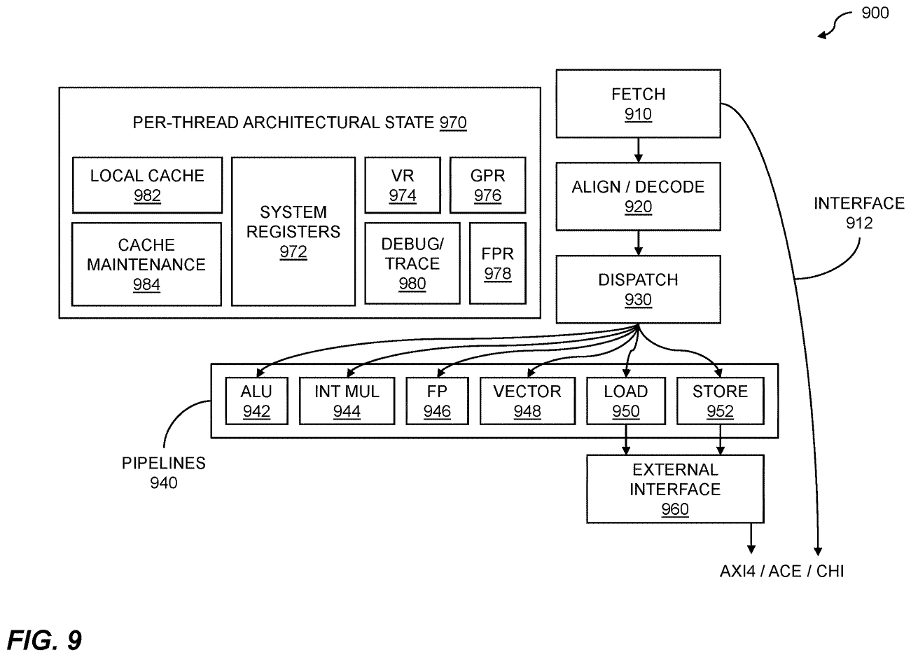

FIG. 9 is a block diagram of a pipeline. One or more pipelines associated with a processor architecture can be used to greatly enhance processing throughput. The processor architecture can be associated with one or more processor cores. Increased processing throughput can be accomplished because multiple operations can be executed in parallel. The increased processing throughput is supported by a vector unit with an activation function accelerator pipeline. In one or more implementations, a processor core is accessed. The processor core executes an instruction set architecture (ISA). The processor core includes a vector unit. The processor core executes an instruction set architecture (ISA). The processor core includes a vector unit. The ISA is extended, wherein the extending includes a custom vector instruction. The custom vector instruction is based on a core activation function. A first activation function within the one or more activation functions is based on the core activation function. The custom vector instruction is implemented in the vector unit. The implementing is based on a plurality of combinational logic cones. The plurality of combinational logic cones calculates a plurality of output bits associated with a result of the core activation function. The custom vector instruction is computed by the processor core, wherein the computing is based on the custom vector instruction. The custom vector instruction accesses, within the vector unit, the plurality of combinational logic cones.

The blocks within the block diagram can be configurable in order to provide varying processing levels. The varying processing levels can be based on processing speed, bit lengths, word lengths, numbers of micro-operations, and so on. The block diagram 900 can include a fetch block 910. The fetch block 910 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 912. The interface can include a standard interface such as one or more industry standard interfaces. The interfaces can include an Advanced extensible Interface (AXI®), an ARM® Advanced extensible Interface (AXI®) Coherence Extensions (ACE®) interface, an Advanced Microcontroller Bus Architecture (AMBA®) Coherence Hub Interface (CHI®), etc.

The block diagram 900 includes an align and decode block 920. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 900 can include a dispatch block 930. The dispatch block can receive decoded instruction packets from the align and decode block. The decoded instruction packets can be used to control a pipeline 940, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 942, integer multiplier pipelines 944, floating-point unit (FPU) pipelines 946, vector unit (VU) pipelines 948, and so on. The dispatch unit can further dispatch instructions to pipelines that can include load pipelines 950, and store pipelines 952. The load pipelines and the store pipelines can access storage such as the common memory using an external interface 960. The external interface can be based on one or more interface standards such as the Advanced extensible Interface (AXI®). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 970. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 972. The system registers can be associated with individual processors, a system comprising multiple processors, and so on. The system registers can include exception and interrupt components, counters, etc. The per-thread architectural state can include further registers such as vector registers (VRs) 974. The vector registers can be grouped in a vector register file and can be used for vector operations. In one or more exemplary implementations, the width of the vector register file is 912 bits. Additional registers, such as general-purpose registers (GPRs) 976 and floating-point registers (FPRs) 978, can be included. These registers can be used for general purpose (e.g., integer) operations, and floating-point operations, respectively. The per-thread architectural state can include a debug and trace block 980. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 982. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 984. The cache maintenance state can include maintenance needed, maintenance pending, and maintenance complete states, etc.

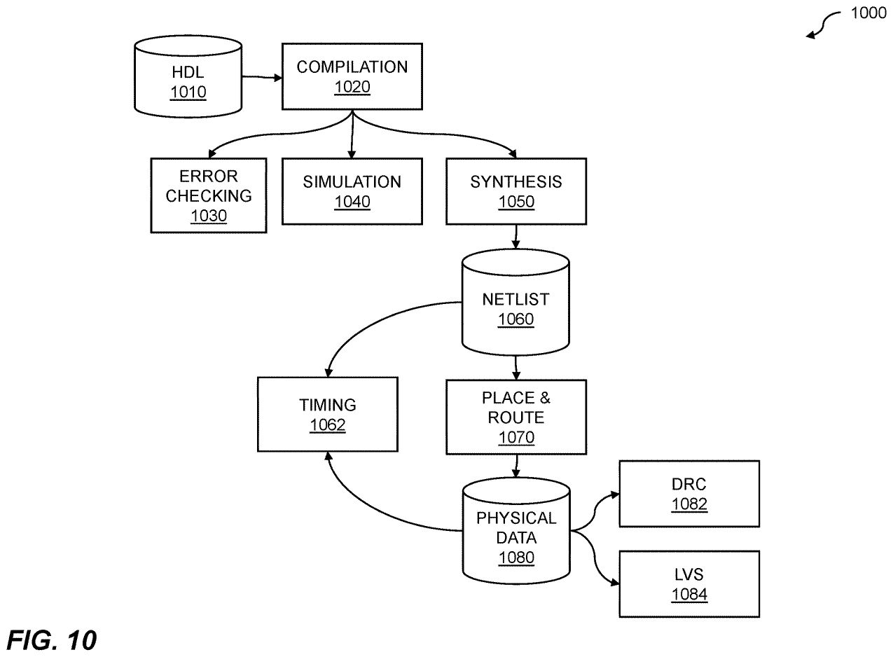

FIG. 10 is a design flow for semiconductor logic generation. Semiconductor logic generation can enable manufacture of a vector unit with an activation function accelerator pipeline. The design flow can be based on one or more design automation tools and can include instructions and/or functions for design, generation of semiconductor logic for, and implementation of integrated circuits that support non-flushing vector micro-operations with VSET. The design flow 1000 can include instructions and/or functions for generation and/or manipulation of design data such as hardware description language (HDL) constructs for specifying structure and operation of an integrated circuit. The design flow 1000 can further perform operations to generate and manipulate Register Level Transfer (RTL) abstractions. These abstractions can include parameterized inputs that enable specifying elements of a design such as a number of elements, sizes of various bit fields, sizes of caches, number of registers, enablement of certain features (such as architectural extensions), and so on. The parameterized inputs can be used as inputs to a logic synthesis process which can create semiconductor logic that implements the gate-level abstraction of the HDL. The gate level data can be further processed and used for fabrication of integrated circuit (IC) devices.

Modern integrated circuit designs are typically created using complex software design automation tools. The design flow 1000 includes a hardware description language (HDL) 1010 of a logic design. The HDL can enable a human to create and test a description of a logic function, logic block, system, etc. they want to design by describing the system using code. Any HDL can be used including Verilog®, VHDL, SystemC, Chisel, and other languages. The code can describe the system at various levels of abstraction. The levels of abstraction can include a high level of abstraction that describes the behavior of the system, at a register transfer level (RTL), which describes the design based on the transfer of data between registers; at a gate level description, which names the particular circuits used and the interconnections between them; and so on. For example, a high level behavioral description may describe multiplication as C=A*B. An RTL level may describe loading data into register A, loading data into register B, performing a multiplication operation, and storing the product of A and B in register C. A circuit level description may name the particular circuits to use and the interconnections among them. At the RTL stage, disclosed implementations can capture both functional behavior and timing relationships. While the behavioral description can be the most user friendly, the RTL description can enable more control over how the design is implemented. Common text file formats, such as “.v”, “.vhd”, are typically used for the HDL source code in the semiconductor design flow.

The HDL source code can be compiled 1020. The compilation can comprise one or more analysis, parsing, and/or elaboration steps. The compilation can result in an executable model of the HDL source code, which can be suitable for further steps of design automation. The executable model can be hierarchical. The compilation process can include error checking 1030. The error checking can include syntactical checking; semantic checking; checking of references to other referenced libraries, designs, and models; etc. One or more implementations may include automated linting tools that detect undeclared signals, mismatched bit widths, or unused variables in HDL code.

One or more implementations may include simulation 1040 of the HDL or RTL code prior to synthesis. Simulation environments can enable verification of design parameters such as functional correctness, timing behavior, and corner cases. By running testbenches against the HDL code, designers can confirm that arbitration logic operates as intended before committing to gate level synthesis. Simulation can also provide visibility into signal waveforms and processor request interactions, ensuring that arbitration criteria are correctly enforced. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation.

Synthesis 1050 tools can be used to map the abstract operations captured by the HDL code into logic gates, flip-flops, cache structures, interconnect structures, etc. This process can enable automated generation of semiconductor logic that can be implemented in silicon, while preserving the intended arbitration and control functions originally specified. The synthesis can produce a gate level netlist 1060 that represents the actual semiconductor logic structures such as described above. The netlist can be a technology-mapped netlist (e.g., mapped to a specific semiconductor fabrication technology). Synthesized netlists may be represented in formats such as EDIF, Liberty, and so on. In some implementations, checking can be performed to ensure that the logic generated by the synthesis tool is equivalent to the logic defined by the HDL source code. This can be accomplished by one or more testbenches, running one or more tests on larger blocks of logic and comparing those to the synthesized circuits, performing formal verification to prove logical equivalence between HDL and the netlist, and so on. Timing 1062 can be performed on the netlist. The timing can generate an initial view including critical paths and/or paths that should be retimed with different synthesis directions. The timing information can be generated from established models of semiconductor devices, gates, etc. that have been selected by the synthesis tool. Estimates for wiring delays can also be included in the timing data.

The gate level netlist can be placed and routed 1070 to produce physical data 1080 which represents layout suitable for fabrication. Examples of place and route tools are Cadence® Innovus®, Synopsis IC Complier®, versatile place and route (VPR), nextpnr, and others. Layout data is often exchanged in GDSII or OASIS formats. These standardized formats enable interoperability across tools and vendors, and support error checking during import/export. Timing 1062 can again be run on the placed and routed design to ensure that the design meets cycle time requirements, taking into account more accurate wire lengths, parasitics, clock domains, and so on. Design rule checks (DRCs) 1082 and layout versus schematic (LVS) 1084 checks can confirm that the generated semiconductor logic adheres to fabrication constraints and matches the intended design. This tool-based flow demonstrates how software code can be transformed into concrete semiconductor logic structures, enabling support for claims directed to logic generation.

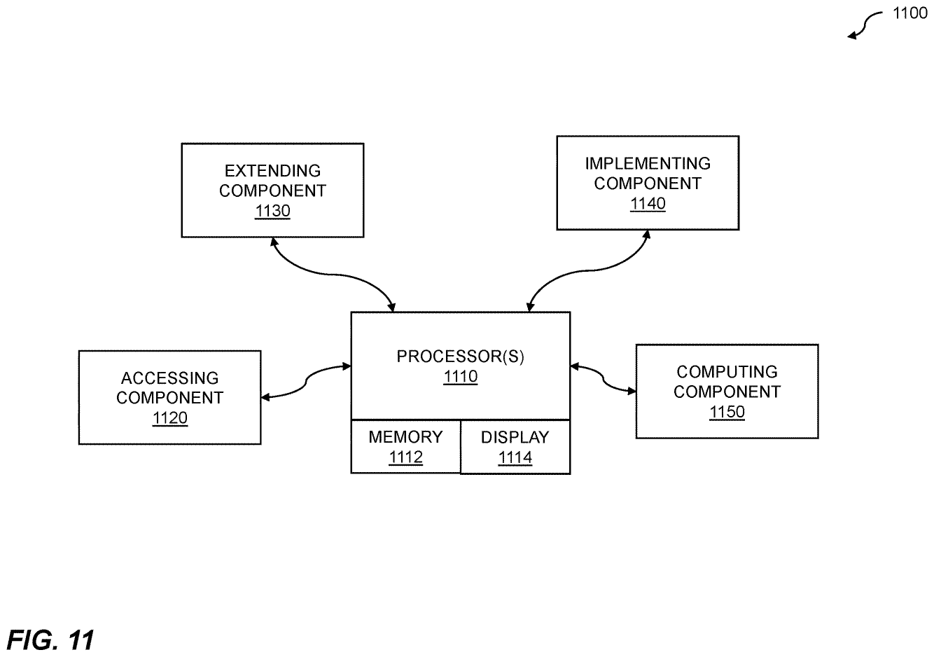

FIG. 11 is a system diagram for a vector unit with an activation function accelerator pipeline. The system 1100 can include instructions and/or functions for design and implementation of integrated circuits that support matrix processing in further support of a vector unit with an activation function accelerator pipeline. The system 1100 can include instructions and/or functions for generation and/or manipulation of design data such as hardware description language (HDL) constructs for specifying structure and operation of an integrated circuit. The system 1100 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool, which in turn creates the semiconductor logic that includes the gate-level abstraction of the design that is used for fabrication of integrated circuit (IC) devices.

The system can include one or more of processors, memories, cache memories, displays, and so on. The system 1100 can include one or more processors 1110. The processors can include standalone processors, processors within integrated circuits or chips, processor cores in FPGAs or ASICs, and so on. The one or more processors 1110 are coupled to a memory 1112, which stores instructions. The memory can include one or more of local memory, cache memory, system memory, etc. The system 1100 can further include a display 1114 coupled to the one or more processors 1110. The display 1114 can be used for displaying data, instructions, operations, micro-operations, core activation functions, activation functions, logic equations, and the like. The operations can include instructions and functions for implementation of integrated circuits, including processor cores. In exemplary implementations, the processor cores can include RISC-V® processor cores. A system comprising the one or more processors 1110, when executing the instructions which are stored in the memory 1112, is configured to enable a vector unit with an activation function accelerator pipeline

The system 1100 can include an accessing component 1120. The accessing component 1120 can include functions and instructions for accessing a processor core, wherein the processor core executes an instruction set architecture (ISA), wherein the processor core includes a vector unit, wherein the vector unit includes one or more execution pipelines, and wherein the processor core calculates one or more activation functions associated with a machine learning model. The processor core can include an ARM core, a MIPS core, and/or other suitable core type. In one or more exemplary implementations, the processor core can include a RISC-V® architecture. The processor core can support vector operations. The RISC-V® architecture can include extensions, where the extensions can enable execution of various arithmetic and logic operations. In exemplary implementations, a RISC-V® architecture can include vector extensions. In exemplary implementations, the vector extensions can include ELEN, VLEN, SEW, LMUL, VLMAX, VL, and VSTART components.

The ISA can be associated with a processor, a multiprocessor, and so on. In embodiments, the ISA comprises a RISC-V ISA. The vector unit within the processor core can process a variety of vector operations. The vector operations can further be used to process matrix operations. The vector operations can include basic vector operations such as addition, subtraction, multiplication, cross products, and division. Vector operations such as those mentioned can be accelerated by a unit, chip, and so on. Discussed previously, the vector unit can include one or more execution pipelines. The one or more execution pipelines can enable pipelined execution of computations such as activation computations. The pipelining can be associated with one or more combinational logic cones within the plurality of logic cones. In embodiments, a maximum number of pipeline stages within one or more combinational logic cones that were pipelined matches a number of pipeline stages within the execution pipeline within the vector unit. The number of stages can include one or more stages. In embodiments, the number of pipeline stages can include four pipeline stages. In a usage example, when fewer than four stages are required, the “unused” stages can simply perform latch-to-latch or register-to-register transfers. Various activation functions can be calculated using the vector unit. The activation functions can include tanh, SILU, SwiGLU, EXP, and so on.

Recall that a machine learning (ML) model can comprise a plurality of layers, where the layers can include one or more of an input layer, a hidden layer, an output layer, and so on. Each layer can include one or more neurons, or nodes, where a neuron can receive one or more activations, can perform a summation on the activations, and can produce an output activation. A neuron within a hidden layer, for example, can receive an activation from one or more neurons in a previous layer. In a usage example, a neuron within a hidden layer can be “fully connected,” where the neuron receives an activation from each neuron in the previous layer. Each activation that is received can be weighted. Thus, each input, such as a binary input, can be assigned a binary output. The effect of a given input on a given output may be zero (e.g., no effect) or may be nonzero (e.g., some effect).

The system 1100 can include an extending component 1130. The extending component 1130 can include functions and instructions for extending the ISA, wherein the extending includes a custom vector instruction, wherein the custom vector instruction is based on a core activation function, and wherein a first activation function within the one or more activation functions is based on the core activation function. The custom vector instruction can be used to efficiently calculate an activation function value by evaluating the core activation function. The evaluating the core activation function can be based on evaluating cones of logic, where a cone of logic is associated with each output bit of the custom vector instruction. By evaluating cones of logic to determine an activation function value, rather than accessing library function calls to determine the activation function value, the value can be determined in four cycles rather than many cycles. The custom vector instruction can be based on a variety of core activation functions. In embodiments, the custom vector instruction can include a vsig instruction. The vsig instruction can be used to evaluate a sigmoid function using cones of logic. The sigmoid function can be used to evaluate activation functions such as a hyperbolic tangent, a sigmoid linear unit function, a swish gated linear unit function, and so on. In other embodiments, a core activation function is based on an exponential function (EXP). The EXP core activation function can be based on a custom vector instruction. In embodiments, the custom vector instruction comprises a vexp instruction. Activation functions that can be based on the custom vexp instruction can include an exponential linear unit, a scaled exponential linear unit, a Gaussian error linear unit, and so on.

The system 1100 can include an implementing component 1140. The implementing component 1140 can include functions and instructions for implementing, in the vector unit, the custom vector instruction, wherein the implementing is based on a plurality of combinational logic cones, wherein the plurality of combinational logic cones calculates a plurality of output bits associated with a result of the core activation function. Recall that the custom vector instruction vsig can be associated with a sigmoid function, and the custom vector instruction vexp can be associated with an exponential function. A cone of logic can include one or more logic gates that generate an output bit for a core logic function. Thus, there can be a cone of logic for each output bit from the core activation function. The output bit is evaluated based on input bit values to the cone of logic. The output bit can be determined based on one or more input bits. Not all input bits need be associated with a given output bit (e.g., “don't care”). The cone of logic can include nonsequential logic (e.g., no store elements) and can be based on logic functions such as AND, NAND, OR, NOR, XOR, XNOR, NOT, and so on. Each cone of logic can be reduced, optimized, and so on. The cones of logic can be pipelined to speed evaluation of the cones of logic. Embodiments can include pipelining one or more combinational logic cones within the plurality of combinational logic cones, wherein the pipelining is based on an execution frequency of the processor core. Once a pipeline has been filled, a result can be obtained every cycle. In embodiments, the implementing can include adding, to an execution pipeline within the one or more execution pipelines, the plurality of combinational logic cones. Discussed previously, a number of pipeline stages can be determined to enhance evaluation of the cones of logic. In embodiments, the number of pipeline stages comprises four pipeline stages. Other numbers of pipeline stages can be included.

The plurality of combinational logical functions can be used to synthesize digital logic hardware. The plurality of combinational logical functions can be minimized, optimized, and so on using one or more digital logic design tools. In a usage example, the transforming includes compressing one or more combinational logic functions within the plurality of combinational logic functions. The number of bits that can be included in the plurality of output bits can be based on a standard such as a floating-point standard. The number of bits that comprise the plurality of output bits can be based on a number of bits associated with each binary input to the machine learning model. In embodiments, each binary input within the plurality of binary inputs comprises a floating-point 16 (FP16) format number. Other floating-point format standards such as IEEE Standard 754-2008 (binary16), bfloat16, and so on can be used.

In embodiments, each combinational logic cone within the plurality of combinational logic cones is based on one or more lookup tables (LUTs). The LUTs can include tables of varying sizes. The LUTs can be populated based on an activation function. Embodiments can include assigning, by each LUT within the one or more LUTs, to each input within a plurality of inputs, an output, wherein the assigning is based on the core activation function. The size of the LUT can become large when all combinational logic functions within a plurality of combinational logic functions are associated with each input bit within the plurality of binary inputs. Since the differences between combinational logic functions can be small, some combinational logic functions can be omitted, relying instead on interpolation. In embodiments, the transforming includes interpolating linearly one or more combinational logic functions within the plurality of combinational logic functions associated with each input bit within the plurality of binary inputs. Other interpolation techniques can be used, such as polynomial interpolation, inverse distance interpolation, spline interpolation, cubic spline interpolation, etc. The linear interpolation can be based on a quantization. In embodiments, the interpolating linearly is based on a quantization of four.

Discussed previously and throughout, a binary output is assigned in a lookup table to each binary input within a plurality of binary inputs. The assigning is based on a core activation function which can be associated with one or more activation functions that can be used by a machine learning model. A variety of techniques can be used to realize the core activation function. Embodiments include programming the one or more activation functions for the machine learning model, wherein the programming includes the vsig instruction. The programming can be based on instructions associated with a processor core, one or more custom instructions, and so on. In embodiments, the programming includes one or more additional ISA instructions, wherein the one or more additional ISA instructions complete the one or more activation functions. The activation functions can include the sigmoid function described above or another activation function. In embodiments, the one or more activation functions comprise a hyperbolic tangent (tan h) function. The tanh function can be based on the sigmoid function, a vsig function, etc. In embodiments, the one or more activation functions comprise a sigmoid linear unit function (SILU). The SILU, which can also be referred to as a “Swish” activation function, can be calculated by multiplying an input value by a result of applying the sigmoid function to the input value. In other embodiments, the one or more activation functions comprise a swish gated linear unit function (SwiGLU). The SwiGLU can be computed by combining a SILU activation function with a gated linear unit (GLU). The GLU can enable control of data through a neural network by selectively permitting or “gating” relevant data to flow through a neural network while filtering out irrelevant data. In further embodiments, the core activation function is based on an exponential function (EXP). In a usage example, an exponential function can be used to compute a hyperbolic tangent value.

Further activation functions can be used. In embodiments, the one or more activation functions comprise an exponential linear unit (ELU). An ELU differs from another activation function, the rectified linear unit (ReLU), in that the ReLU provides only positive values while the ELU provides both positive and negative values. The ReLU outputs zero for negative values. In embodiments, the one or more activation functions comprise a scaled exponential linear unit (SELU). The SELU differs from the ELU in that the SELU can normalize an output from a layer within a machine learning (ML) model network. The normalization can prevent vanishing gradients (small) and exploding gradients (large). The control of the gradients can maintain a stable distribution of activations throughout a network.

The system 1100 can include computing component 1150. The computing component 1150 can include functions and instructions for computing, by the processor core, the first activation function, wherein the computing is based on the custom vector instruction, and wherein the custom vector instruction accesses, within the vector unit, the plurality of combinational logic cones. Recall that the activation function is based on a core activation function. Thus, by computing the custom vector instruction based on the combinational logic cones, a value for the first activation function can be computed in four cycles, which is fewer cycles than computing the first activation function based on library function calls. In a usage example, tanh (x) can be calculated in four vector cycles based on the vsig instruction compared to computing tanh (x) based on library function calls to evaluate a sigmoid (x) function. The computing can include, for every output bit of an activation function within the machine learning model, a corresponding combinational logic function within the plurality of combinational logic functions. The executing can include executing one or more software instructions, where the software instructions include the custom instruction. The custom instruction can include a custom vector instruction. Recall that the custom instruction can be based on an instruction set architecture associated with a processor architecture. In embodiments, the ISA comprises a RISC-V® ISA. The custom instruction can include a custom vector instruction. The custom instruction can further be executed in a processor emulator. The custom instruction can also be executed in hardware, where the hardware includes hardware associated with the plurality of combinational logic functions. In embodiments, the computing is based on a vector state, wherein the vector state includes a vector multiplier (vmul).

The system 1100 can include a computer program product embodied in a non-transitory computer readable medium for matrix processing, the computer program product comprising code which causes one or more processors to generate semiconductor logic for: accessing a processor core, wherein the processor core executes an instruction set architecture (ISA), wherein the processor core includes a vector unit, wherein the vector unit includes one or more execution pipelines, and wherein the processor core calculates one or more activation functions associated with a machine learning model; extending the ISA, wherein the extending includes a custom vector instruction, wherein the custom vector instruction is based on a core activation function, and wherein a first activation function within the one or more activation functions is based on the core activation function; implementing, in the vector unit, the custom vector instruction, wherein the implementing is based on a plurality of combinational logic cones, wherein the plurality of combinational logic cones calculates a plurality of output bits associated with a result of the core activation function; and computing, by the processor core, the first activation function, wherein the computing is based on the custom vector instruction, and wherein the custom vector instruction accesses, within the vector unit, the plurality of combinational logic cones.

The system 1100 can include a computer system for matrix processing comprising: a memory which stores instructions; one or more processors coupled to the memory, wherein the one or more processors, when executing the instructions which are stored, are configured to: access a processor core, wherein the processor core executes an instruction set architecture (ISA), wherein the processor core includes a vector unit, wherein the vector unit includes one or more execution pipelines, and wherein the processor core calculates one or more activation functions associated with a machine learning model; extend the ISA, wherein the extending includes a custom vector instruction, wherein the custom vector instruction is based on a core activation function, and wherein a first activation function within the one or more activation functions is based on the core activation function; implement, in the vector unit, the custom vector instruction, wherein the implementing is based on a plurality of combinational logic cones, wherein the plurality of combinational logic cones calculates a plurality of output bits associated with a result of the core activation function; and compute, by the processor core, the first activation function, wherein the computing is based on the custom vector instruction, and wherein the custom vector instruction accesses, within the vector unit, the plurality of combinational logic cones.

As can now be appreciated, exemplary implementations can improve processor performance for matrix processing by executing a custom instruction, where the custom instruction augments an instruction set architecture (ISA). The custom instruction executes based on a plurality of combinational logic functions, where the combinational logic functions are transformed from a lookup table (LUT). Within the LUT, a binary output is assigned to each binary input within a plurality of binary inputs. The assigning is based on a core activation function. The core activation function can include a sigmoid function, a hyperbolic tangent (tanh) function, a sigmoid linear unit (SILU) function, a swish gated linear unit (SwiGLU) function, and so on. The custom instruction therefore executes in hardware, rather than relying on function calls to a software library. Thus, the custom instruction is able to perform operations based on activation functions executing in hardware faster than is possible with calls to software functions. In this way, exemplary implementations can enable fast execution of activation functions that form the bases of complex machine learning (ML) models.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for matrix processing comprising:
accessing a processor core, wherein the processor core executes an instruction set architecture (ISA), wherein the processor core includes a vector unit, wherein the vector unit includes one or more execution pipelines, and wherein the processor core calculates one or more activation functions associated with a machine learning model;
extending the ISA, wherein the extending includes a custom vector instruction, wherein the custom vector instruction is based on a core activation function, and wherein a first activation function within the one or more activation functions is based on the core activation function;
implementing, in the vector unit, the custom vector instruction, wherein the implementing is based on a plurality of combinational logic cones, wherein the plurality of combinational logic cones calculates a plurality of output bits associated with a result of the core activation function; and
computing, by the processor core, the first activation function, wherein the computing is based on the custom vector instruction, and wherein the custom vector instruction accesses, within the vector unit, the plurality of combinational logic cones.

2. The method of claim 1 wherein each combinational logic cone within the plurality of combinational logic cones is based on one or more lookup tables (LUTs).

3. The method of claim 2 further comprising assigning, by each LUT within the one or more LUTs, to each input within a plurality of inputs, an output, wherein the assigning is based on the core activation function.

4. The method of claim 1 further comprising pipelining one or more combinational logic cones within the plurality of combinational logic cones, wherein the pipelining is based on an execution frequency of the processor core.

5. The method of claim 4 wherein the implementing includes adding, to an execution pipeline within the one or more execution pipelines, the plurality of combinational logic cones.

6. The method of claim 5 wherein a maximum number of pipeline stages within one or more combinational logic cones that were pipelined matches a number of pipeline stages within the execution pipeline within the vector unit.

7. The method of claim 6 wherein the number of pipeline stages comprises four pipeline stages.

8. The method of claim 6 wherein the processor core includes a vector register file, wherein each vector register within the vector register file comprises 2048 bits.

9. The method of claim 8 wherein the activation function is based on a floating-point 16 data format (FP16).

10. The method of claim 9 further comprising performing 128 core activation functions within four cycles of the processor core.

11. The method of claim 9 wherein the computing is based on a vector state, wherein the vector state includes a vector multiplier (vmul).

12. The method of claim 11 wherein the implementing includes creating, by a decode unit within the processor core, one or more vector micro-operations, wherein each operation within the one or more vector micro-operations is based on the core activation function, and wherein the creating is further based on the vmul.

13. The method of claim 12 further comprising executing 1024 core activation functions within 11 cycles of the processor core.

14. The method of claim 1 wherein the core activation function is based on a sigmoid function.

15. The method of claim 14 wherein the custom vector instruction comprises a vsig instruction.

16. The method of claim 15 wherein the activation function comprises a hyperbolic tangent (tanh) function.

17. The method of claim 15 wherein the activation function comprises a sigmoid linear unit function (SILU).

18. The method of claim 15 wherein the activation function comprises a swish gated linear unit function (SwiGLU).

19. The method of claim 1 wherein the core activation function is based on an exponential function (EXP).

20. The method of claim 19 wherein the custom vector instruction comprises a vexp instruction.

21. The method of claim 20 wherein the activation function comprises an exponential linear unit (ELU).

22. The method of claim 20 wherein the activation function comprises a scaled exponential linear unit (SELU).

23. The method of claim 1 wherein the core activation function and the activation function comprise a Gaussian error linear unit (GELU).

24. A computer program product embodied in a non-transitory computer readable medium for matrix processing, the computer program product comprising code which causes one or more processors to generate semiconductor logic for:
accessing a processor core, wherein the processor core executes an instruction set architecture (ISA), wherein the processor core includes a vector unit, wherein the vector unit includes one or more execution pipelines, and wherein the processor core calculates one or more activation functions associated with a machine learning model;
extending the ISA, wherein the extending includes a custom vector instruction, wherein the custom vector instruction is based on a core activation function, and wherein a first activation function within the one or more activation functions is based on the core activation function;
implementing, in the vector unit, the custom vector instruction, wherein the implementing is based on a plurality of combinational logic cones, wherein the plurality of combinational logic cones calculates a plurality of output bits associated with a result of the core activation function; and
computing, by the processor core, the first activation function, wherein the computing is based on the custom vector instruction, and wherein the custom vector instruction accesses, within the vector unit, the plurality of combinational logic cones.

25. A computer system for matrix processing comprising:
a memory which stores instructions;
one or more processors coupled to the memory, wherein the one or more processors, when executing the instructions which are stored, are configured to:
access a processor core, wherein the processor core executes an instruction set architecture (ISA), wherein the processor core includes a vector unit, wherein the vector unit includes one or more execution pipelines, and wherein the processor core calculates one or more activation functions associated with a machine learning model;
extend the ISA, wherein the extending includes a custom vector instruction, wherein the custom vector instruction is based on a core activation function, and wherein a first activation function within the one or more activation functions is based on the core activation function;
implement, in the vector unit, the custom vector instruction, wherein the implementing is based on a plurality of combinational logic cones, wherein the plurality of combinational logic cones calculates a plurality of output bits associated with a result of the core activation function; and
compute, by the processor core, the first activation function, wherein the computing is based on the custom vector instruction, and wherein the custom vector instruction accesses, within the vector unit, the plurality of combinational logic cones.
